(19) United States
(12) Patent Application Publication
(10) Pub. No.: US 2005/0099728 A1
(43) Pub. Date: May 12, 2005

(54) Disk drive, head slider, and head supporting device

(75) Inventors: Zhisheng Deng, Moriguchi-shi (JP); Yoshihiro Ueno, Hirakata-shi (JP)

Correspondence Address: RATNERPRESTIA, P O BOX 980, VALLEY FORGE, PA, 19482-0980, US

(73) Assignee: Matsushita Electric Industrial Co.

(21) Appl. No.: 10/980,214

(22) Filed: Nov. 3, 2004

(30) Foreign Application Priority Data
Nov. 10, 2003 (JP) 2003-379756

(51) Int. Cl. G11B 5/60

(52) U.S. Cl. 360/236.2; 360/235.7

(57) ABSTRACT

A disk drive including: (a) a recording medium; and (b) a head slider having (i) a first air bearing on the side of an air inlet end, and (ii) a second air bearing on the side of an air outlet end. The second air bearing includes a positive pressure generating portion on the side of the outermost air outlet end, and a first arm and a second arm, respectively extending from both ends of the positive pressure generating portion toward the air inlet end. Extending directions of the first arm and the second arm are defined so that the pressure generated by the second air bearing when the head slider is used on the inner diameter side of the recording medium is higher than the pressure generated by the second air bearing when the head slider is used on the outer diameter side of the recording medium.

### BACKGROUND OF THE INVENTION

1. Field of the Invention

The present invention relates to a disk drive using a floating head slider, such as a magnetic disk drive, and a head slider and a head supporting device used therefore.

2. Background Art

Conventionally discussed is a problem of stabilizing the flying height of the head slider in a disk drive, such as a magnetic disk drive, on inner and outer diameter of the recording media. Because the recording medium in a disk drive is generally rotating at a constant rotation number, the relative velocity of airflow between the head slider and the recording medium is different on the inner and outer diameter thereof, and this difference causes fluctuations of the flying height of the head slider. When a disk drive is structured by a head slider having large fluctuations of the flying height between the outer and inner diameter, the residual magnetism in unit areas recorded on a recording media are different between the outer and inner diameter, or noises in adjacent tracks are erroneously reproduced.

On the other hand, improvements in memory capacity and the density of a recording media are required for a disk drive. With this requirement, a floating type head slider used for a disk drive has an important problem of placement of the head as adjacent as possible to the recording media. Now, it is required to minimize the flying height of the floating type head slider for use in a magnetic disk drive to approx. 10 nm from the recording media.

Various discussions have been made on a magnetic disk drive using such a low-floating head slider to stabilize the flying height of the head slider. Proposed as one example is a technique for inhibiting a difference in flying height between the inner and outer diameter of a recording medium within approximately 1 nm, by adjusting a pivot position at which a suspension for imparting load to the head slider is in contact with the head slider (see Japanese Patent Unexamined Publication No. 2002-203305, for example).

Further, in recent years, there has been an increasing demand of incorporating a magnetic disk drive into mobile portable information equipment, such as a portable telephone, personal digital assistant (PDA), digital camera, and small notebook computer, by utilizing the advantages of its large memory capacity and lower cost than that of semiconductor memories.

To incorporate a magnetic disk drive into such mobile information equipment, not only the downsizing of the magnetic disk drive itself and the smaller flying height of the head slider, but also portability of the disk drive is required. For this reason, stable recording and reproduction of signals against shocks caused by a drop or external shocks, i.e. improvements in shock resistance, is a significant problem.

To address this problem of improvements in shock resistance, the applicants have proposed a head slider in which an air bearing is provided on each side of air inlet and outlet ends on the base surface, the surfaces of these two air bearings faced with a recording medium (hereinafter referred to as an air lubricating surface) are appropriately shaped and the pressure generated by the bearings are controlled so that the shocks are absorbed and the collision between the head slider and the recording media can be prevented (see Japanese Patent Publication Nos. 2003-30946 and 2003-115178, for example). Such a head slider can provide a head slider having a high shock resistance of approximately 750 G (1 G=9.8 m/s²).

However, in incorporating a magnetic disk of the Patent Reference 1 into portable mobile information equipment, fluctuations in the flying height on the inner and outer diameter of the magnetic disk and the flying height are decreased, but the improvements in the shock resistance are not fully addressed.

### SUMMARY OF THE INVENTION

The present invention addresses the above problems, and aims to provide a disk drive capable of achieving higher shock resistance and a lower flying height, inhibiting fluctuations of the flying height between the inner and outer diameter of a recording media, and a head slider and a head supporting device therefor.

A disk drive of the present invention includes: (a) a rotating disc-shaped recording medium; and (b) a head slider floated by an airstream flowing between the recording medium and the head slider, used at different skew angle with respect to recording tracks on inner and outer diameter of the recording medium, and having (i) a first air bearing on the side of an inlet end and (ii) a second air bearing on the side of an air outlet end. The second air bearing of the head slider includes a positive pressure generating portion provided on the side of the outermost air outlet end, and a first arm, and a second arm provided on the inner diameter side of the first arm, respectively extending from both ends of the positive pressure generating portion toward the air inlet end. The extending directions of the first and second arms of the head slider are defined so that the pressure generated by the second air bearing when the head slider is used on the inner diameter side of the recording medium is higher than the pressure generated by the second air bearing when the head slider is used on the outer diameter side.

Because the disk drive has a head slider that has an air bearing on each side of the air inlet end and air outlet end in this structure, external shocks can be absorbed. For this reason, a disk drive having a small flying height but excellent shock resistance can be provided. Further, the extending directions of the first and second arms of the head slider are defined so that the pressure generated by the second air bearing when the head slider is used on the inner diameter side of the recording medium is higher than the pressure generated when the head slider is used on the outer diameter side. This can inhibit an increase in the flying height caused by the increased air inlet velocity on the outer diameter side. Thus, fluctuations of the flying height on the inner and outer diameter sides can be inhibited.

Alternatively, the extending direction of the first arm can be defined so that the pressure generated between the first arm and a recess surrounded by the first and second arms and the positive pressure generating portion when the head slider is used on the outer diameter side of the recording medium is lower than the pressure generated between the first arm and the recess when the head slider is used on the inner diameter side of the recording medium.

Because the extending direction of the first arm are defined so that the pressure generated between the first arm and the recess when the head slider is used on the outer diameter side is lower than the pressure generated when the head slider is used on the inner diameter side in this structure, fluctuations of the flying height on the inner and outer diameter sides can easily be inhibited.

The second arm can extend in the direction as to have a smaller angle than the air inlet directions when the head slider is used on the outer and inner diameter sides of the recording medium. The first arm can extend in the direction as to have a smaller angle than the air inlet direction when the head slider is used on the outer diameter side of the recording medium and a larger angle than the air inlet direction when the head slider is used on the inner diameter side of the recording medium.

This structure allows generation of sufficient positive pressure between the second arm and the recess in all the areas on the inner and outer diameter sides, and also generation of positive pressure on the inner diameter side, and negative pressure on the outer diameter side between the first arm and the recess. Thus, while achieving shock resistance, this structure can inhibit fluctuations of the flying height on inner and outer diameter.

Further, the disk drive can be structured so that the head slider has a head on the outermost surface of the second air bearing on the side of the outermost air outlet end thereof.

This structure can provide a highly shock-resistant disk drive, because the head is provided on the second air bearing that has rigid air film.

Further, the extending direction of the first arm of the head slider can range from −30° to 10° with respect to the longitudinal direction of the head slider.

This structure can further achieve a disk drive capable of inhibiting fluctuations of the flying height on the inner and outer diameter of the recording medium.

Additionally, the disk drive can be structured to satisfy the following relation:
0.3≦A/(A+C)≦0.9,
where C is the width of the first arm of the head slider in the direction orthogonal to the extending direction of the first arm, and A is a half value of the width of the recess on the side of the air inlet end in the direction orthogonal to the extending direction of the first arm.

This structure can further achieve a disk drive further inhibiting fluctuations of the flying height on the inner and outer diameter of the recording medium.

Further, the disk drive can be structured to have a pair of side rails in the first air bearing of the head slider.

This structure can further achieve a structure resistant to vibrations in the roll direction.

Additionally, the disk drive can be structured so that the pair of side rails, the first arm, the second arm, and the positive pressure generating portion are provided at the same height from the base surface.

This structure can achieve a highly practical and productive structure.

The disk drive is structured to have a head supporting device that includes a suspension for imparting a predetermined urging force to the head slider from the direction opposite to the side having the first air bearing and the second air bearing.

This structure allows the suspension to hold the head slider, thus achieving high shock resistance.

Additionally, the suspension can be structured to have a pivot for imparting the predetermined urging force to the head slider.

With this structure, the head slider can operatively be held in the pitch and roll directions. Thus, a disk drive having much higher shock resistance can be provided.

The disk drive can be structured to include a driving means for rotating the recording medium, a pivoting means for pivoting the head supporting device radially of the recording medium, and a controlling means for controlling rotation of the driving means and pivoting of the pivoting means.

This structure can provide a disk drive in which the pivoting means can pivot the head supporting device to move the head slider to desired track positions.

Further, when the position where the pivot of the head supporting device is in contact with the head slider is set to a pivot position, the projection of the gravitational center of the head slider and the projection of the pivot position onto the recording medium can substantially coincide with each other.

This structure prevents external shocks from generating the moment of inertia in the head slider, and the head slider is unlikely to move. Thus, a disk drive with excellent shock resistance can be provided.

The recording medium can be a magnetic recording medium, and the head can be a magnetic head.

This structure can provide a shock-resistant magnetic disk drive that has a small flying height and can inhibit fluctuations of the flying height on the inner and outer diameter.

Next, a head slider of the present invention is floated by an airstream flowing between the head slider and a rotating disc-shaped recording medium and used at different skew angles with respect to recording tracks on the inner and outer diameter of a recording medium, and includes a first air bearing on the side of an air inlet end and a second air bearing on the side of an air outlet end. The second air bearing of the head slider includes a positive pressure generating portion provided on the side of the outermost air outlet end, and a first arm and a second arm provided on the inner diameter side of the first arm, respectively extending from both ends of the positive pressure generating portion toward the air inlet end. The extending directions of the first arm and the second arm of the head slider are defined so that the pressure generated by the second air bearing when the head slider is used on the inner diameter side of the recording medium is higher than the pressure generated by the second air bearing when the head slider is used on the outer diameter side of the recording medium.

In this structure, an air bearing is provided at each side of the air inlet end and air outlet end. Thus, even external shocks can be absorbed, and a highly shock-resistant head slider even with a small flying height can be provided. Further, the extending directions of the first arm and second arm of the head slider are defined so that the pressure generated by the second air bearing when the head slider is used on the inner diameter side of the recording medium is higher than the pressure generated by the second air bearing when the head slider is used on the outer diameter side of the recording medium. This can inhibit an increase in the flying height caused by the increased air inlet velocity on the outer diameter side, thus inhibiting fluctuations of the flying height on the inner and outer diameter.

Next, a head supporting device of the present invention includes the head slider of the present invention and a suspension for imparting a predetermined urging force from the direction opposite to the side having the first and second air bearings. This structure can provide a supporting device appropriate for a highly shock-resistant disk drive with a small flying height and fluctuations of the flying height.

As described above, a disk drive, head slider, and head supporting device of the present invention can provide a disk device that has high shock resistance, a small flying height, and can inhibit fluctuations of the flying height on the inner and outer diameter sides of the recording medium, and a head slider and head supporting device appropriate for the disk device.

### BRIEF DESCRIPTION OF THE DRAWINGS

FIG. 1 is a perspective view of an essential part of a disk drive in accordance with an exemplary embodiment of the present invention.

FIG. 2 is a perspective view of an essential part of a head supporting device incorporated in the disk drive in accordance with the exemplary embodiment of the present invention.

FIG. 3 is a drawing for illustrating a definition of a skew angle of the disk drive in accordance with the exemplary embodiment of the present invention.

FIG. 4 is a perspective view showing a shape of an air lubricating surface of a head slider in accordance with the exemplary embodiment of the present invention.

FIG. 5 is a plan view showing the shape of the air lubricating surface of the head slider in accordance with the exemplary embodiment of the present invention.

FIG. 6 is a graph showing fluctuations of a flying height of the head slider from an inner diameter side to an outer diameter side of a recording medium in the disk drive in accordance with the exemplary embodiment of the present invention.

FIG. 7 is a perspective view showing a shape of an air lubricating surface of a head slider in accordance with a comparative example of the present invention.

FIG. 8 is a plan view showing the shape of the air lubricating surface of the head slider in accordance with the comparative example of the present invention.

FIG. 9 is a graph showing fluctuations of a flying height of the head slider from an inner diameter side to an outer diameter side of a recording medium in a disk drive incorporating the head slider of the comparative example of the present invention.

FIG. 10A is a graph showing pressure distribution of the head slider of the comparative example of the present invention on the outer diameter side of the recording medium.

FIG. 10B is a graph showing pressure distribution of the head slider of the comparative example of the present invention on the inner diameter side of the recording medium.

FIG. 11A is a graph showing pressure distribution of the head slider in accordance with the exemplary embodiment of the present invention on the outer diameter side of the recording medium.

FIG. 11B is a graph showing pressure distribution of the head slider in accordance with the exemplary embodiment of the present invention on the inner diameter side of the recording medium.

FIG. 12A is a plan view showing the structure of the air lubricating surface of the head slider in accordance with the exemplary embodiment of the present invention.

FIG. 12B is a diagram showing pressure distribution generated on the outer diameter side by a second air bearing of the head slider in accordance with the exemplary embodiment of the present invention.

FIG. 12C is a diagram showing pressure distribution generated on the inner diameter side by the second air bearing of the slider in accordance with the exemplary embodiment of the present invention.

FIG. 13A is a graph showing fluctuations of a flying height on inner and outer diameter sides when an extending direction of the first arm of the head slider in accordance with the exemplary embodiment of the present invention is changed.

FIG. 13B is a diagram illustrating a definition of the extending direction of the first arm of the head slider in accordance with the exemplary embodiment of the present invention.

FIG. 14A is a diagram illustrating a definition of a width of the first arm of the head slider in accordance with the exemplary embodiment of the present invention.

FIG. 14B is a graph showing fluctuations of a flying height on inner and outer diameter sides of the recording media when the width of the first arm of the head slider in accordance with the exemplary embodiment of the present invention is changed.

FIG. 15 is a graph showing results of comparing shock resistance between the head slider of the exemplary embodiment and the head slider of the comparative example of the present invention.

### PREFERRED EMBODIMENT OF THE INVENTION

An exemplary embodiment of the present invention is detailed hereinafter with reference to the accompanying drawings.

### Exemplary Embodiment

A detailed description is provided of the structure of a disk drive in accordance with the exemplary embodiment with reference to the accompanying drawings.

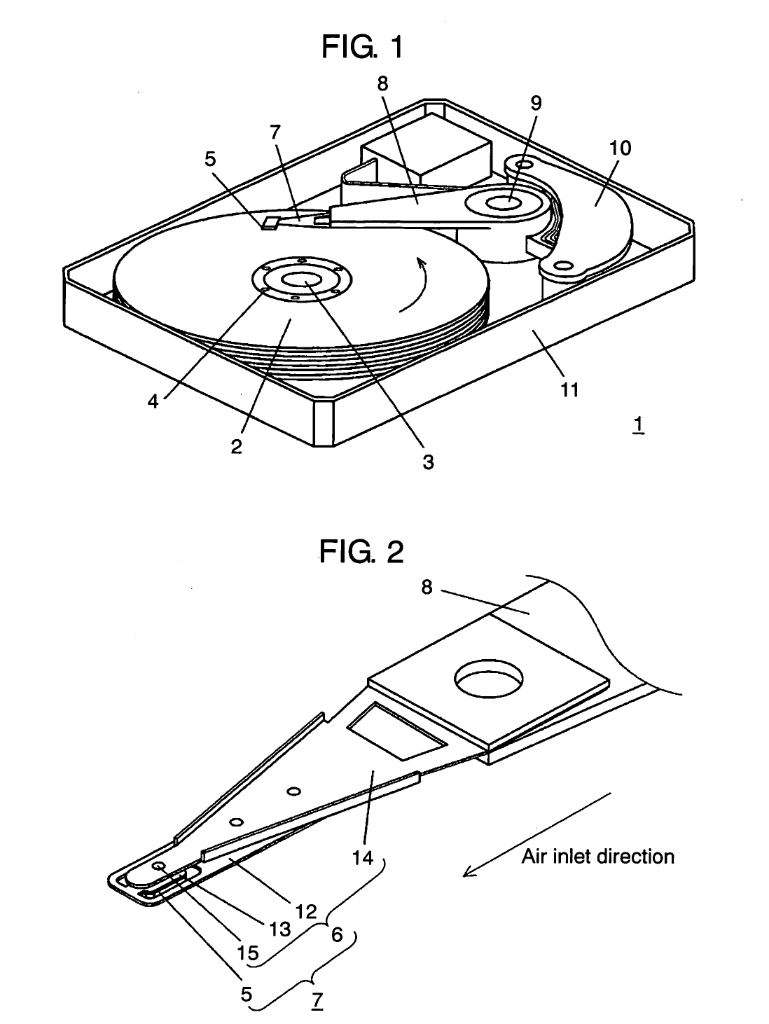

FIG. 1 is a perspective view of an essential part of disk drive 1 in accordance with the exemplary embodiment of the present invention. In the description of this embodiment, a magnetic disk drive is used as an example of a disk drive.

With reference to FIG. 1, disc-shaped recording medium (hereinafter simply referred to as a recording medium) 2 is rotatably supported by main shaft 3 and rotated by driving means 4. As this driving means 4, a spindle motor can be used, for example.

Head slider 5, which will be described later, has a magnetic head (not shown) for recording signals in and reproducing from recording medium 2, and is held at one end of head supporting device 7. This head supporting device 7 is fixed onto actuator arm 8. Actuator arm 8 is pivotally connected to actuator shaft 9.

As pivoting means 10 for pivoting actuator arm 8, a voice coil motor can be used, for example. Used in this voice coil motor is Lorentz force generated by the interaction between the magnetic field of a magnet (not shown) in housing 11 and the electric current flowing through a coil (not shown) at the other end of actuator arm 8. Pivoting means 10 pivots actuator arm 8 and allows the actuator arm to move head slider 5 to given track positions on recording medium 2. Housing 11 hold these components in predetermined positions.

FIG. 2 is a perspective view of an essential part of head supporting device 7 incorporated in disk drive 1 in accordance with the exemplary embodiment of the present invention.

Head supporting device 7 includes suspension 6 and head slider 5. Head slider 5 is attached onto tongue 13 provided at the tip of one end of slider holder 12. The other end of slider holder 12 is fixed to relatively rigid beam 14.

As slider holder 12, a gimbal spring is used, for example. Slider holder 12 allows for the pitch and roll movements of head slider 5 to a certain degree. Head slider 5 can be attached onto tongue 13 using an adhesive, for example. Slider holder 12 can be fixed to beam 14 by welding, for example.

One end of beam 14 has pivot 15 on the back surface thereof. Pivot 15 imparts a predetermined load to head slider 5. Thus, the predetermined load is applied from beam 14 to head slider 5 via this pivot 15. Hereinafter, the point where this pivot 15 is in contact with head slider 5 is referred to as a pivot position.

Head supporting device 7 is structured so that the projection of the gravitational center of head slider 5 and the projection of the pivot position onto recording medium 2 coincide with each other. This structure prevents head slider 5 from generating the moment of inertia in the pitch and roll directions even when shocks are applied thereto. Thus, a head supporting device having excellent shock resistance can be provided.

When signals are recorded into or reproduced from rotating recording medium 2 in such disk drive 1, head slider 5 undergoes two different forces: an urging force applied from beam 14 in the direction as to approach recording medium 2 via pivot 15; and a positive pressure for separating head slider 5 from recording medium 2. An airstream flowing between head slider 5 and recording medium 2 generates this positive pressure by rotation of recording medium 2. The balance of these two forces stably floats head slider 5 above recording medium 2. With this flying height kept constant, pivoting means 10 pivots to position a head element mounted on head slider 5 to desired recording tracks on recording medium 2 for recording and reproduction. Incidentally, the floating force of head slider 5 from recording medium 2 varies with the design of the shape of the surface of head slider 5 faced with recording medium 2 (hereinafter referred to as an air lubricating surface). The shape of the air lubricating surface of head slider 5 of this embodiment will be described later.

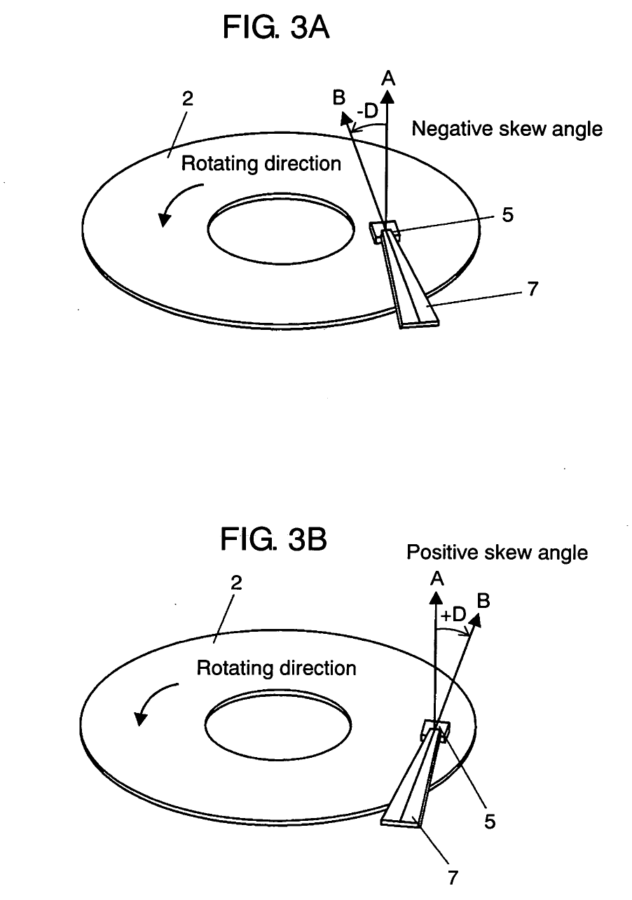

Now, for simplifying the descriptions hereinafter, the definition of skew angle D is described. FIG. 3 is a drawing for illustrating the definition of skew angle D of disk device 1 in accordance with the exemplary embodiment of the present invention. FIG. 3A shows that skew angle D is negative. FIG. 3B shows that skew angle D is positive.

As shown in FIG. 3A, set the direction of a tangent line of the recording tracks on recording medium 2 (air inlet direction) to A, and the direction in which the centerline of head slider 5 is extended in the direction opposite to head supporting device 7 to B. The angle formed by direction B and direction A is skew angle D. When direction B is oriented to the inner side of recording medium 2 with respect to direction A, skew angle D is negative. On the other hand, as shown in FIG. 3B, when direction B is oriented to the outer side of recording medium 2 with respect to direction A, skew angle D is positive. Based on this idea, descriptions are given below.

Next, detailed descriptions are provided of the structure of the air lubricating surface of head slider 5 incorporated in disk drive 1 of the exemplary embodiment of the present invention.

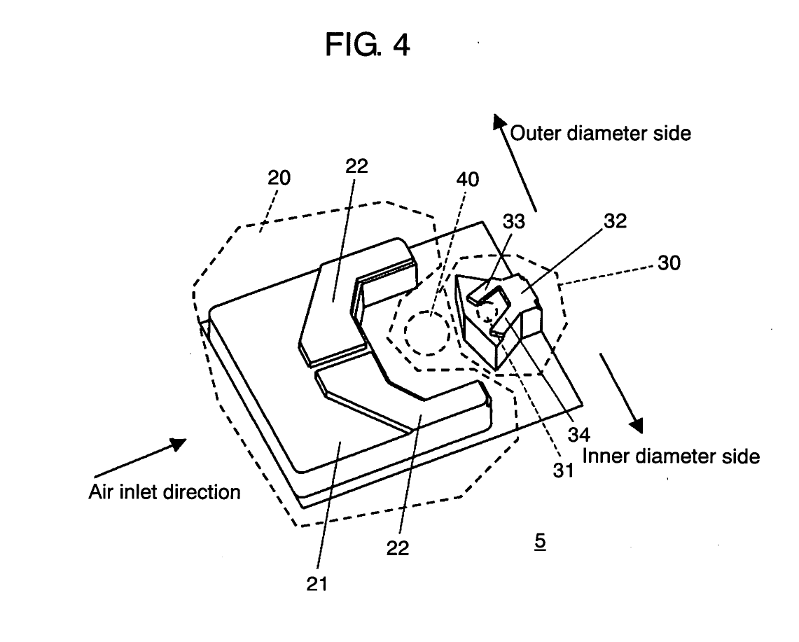

FIG. 4 is a perspective view showing a shape of the air lubricating surface of head slider 5 incorporated in disk drive 1 of the exemplary embodiment. In FIG. 4, for accurate description of the shape of the air lubricating surface of head slider 5, the description of the structure under the base surface is omitted.

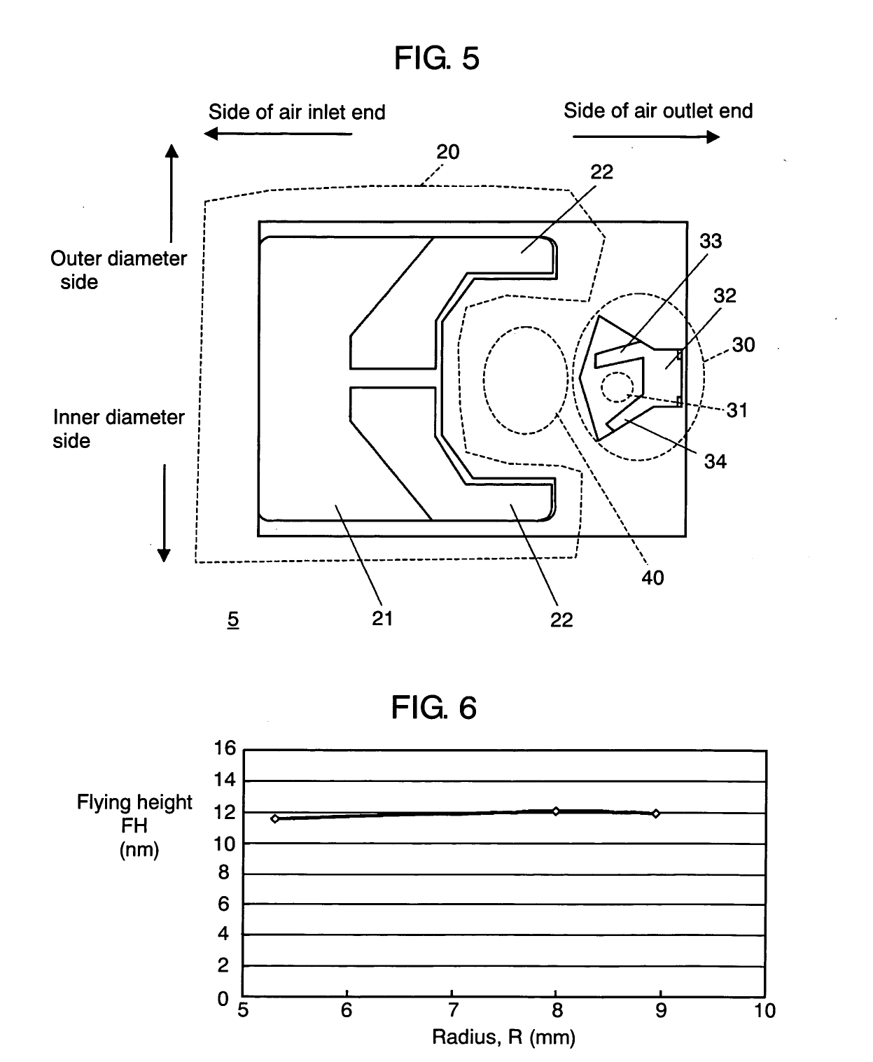

FIG. 5 is a plan view showing the shape of the air lubricating surface of head slider 5 of the exemplary embodiment. In FIG. 5, the left side of head slider 5 is the side of an air inlet end, and the right side is the side of an air outlet end. The upper side of head slider 5 is the outer diameter side of recording medium 2, and the lower side of head slider 5 is the inner diameter side of recording medium 2.

In this description, head slider 5 is sized so that long dimension×short dimension in FIG. 5=1.235 mm×1.00 mm (so-called 30% slider or PICO slider). In disk drive 1, the size of recording medium 2 is 0.85 in. (8.9 mm in radius). Skew angle DI of head slider 5 along the innermost circumference (the position approximately 5.2 mm from the center and hereinafter referred to as an inner diameter side) of recording medium 2 is −16.3°. Skew angle DO along the outermost circumference (the position approximately 8.9 mm from the center and hereinafter referred to as an outer diameter side) of recording medium 2 is 4.8°. The rotational speed of recording medium 2 is 3,600 rpm. The distance from the central rotating shaft of actuator shaft 9 to the pivot position of head slider 5 is 11.6 mm. Further, the load applied from beam 14 to head slider 5 in the direction as to make head slider 5 adjacent to recording medium 2 is 1 gf.

Now, detailed descriptions are provided of the shape of the air lubricating surface of head slider 5 incorporated in disk drive 1 in accordance with the exemplary embodiment of the present invention. As shown FIGS. 4 and 5, head slider 5 includes, from the side of the air inlet end, first air bearing 20, and second air bearing 30 formed at the side of the air outlet end to sandwich negative pressure generating portion (base surface) 40 therebetween.

First air bearing 20 and second air bearing 30 generate positive pressure (i.e. pressure in the direction as to separate recording medium 2 and head slider 5) when air flows between head slider 5 and recording medium 2. Structuring the air lubricating surface to include two air bearings 20 and 30 in the direction of the airstream to sandwich negative pressure generating portion 40 in this manner improves shock resistance of head slider 5, as described in the Patent References 2 and 3.

Further, first air bearing 20 includes first step 21, and a pair of side rails 22 provided in a position higher than first step 21, both for generating larger positive pressure. Providing the pair of side rails 22 can improve the stability of head slider 5 in the roll direction.

Incidentally, the height from the base surface to first step 21 is approximately 700 nm. The height from first step 21 to side rails 22 is approximately 100 nm.

Next, second air bearing 30 includes second step 31 and positive pressure generating portion 32. Making second step 31 in flush with first step 21, and positive pressure generating portion 32 in flush with side rails 22 improves productivity and thus practicality.

From positive pressure generating portion 32, first arm 33 formed on the outer diameter side (upper side in FIG. 5) of recording medium 2 and second arm 34 formed on the inner diameter side (lower side in FIG. 5) of recording medium 2 extend toward the side of the air inlet end. Thus, second step 31 forms a recess surrounded by first arm 33, second arm 34, and positive pressure generating portion 32. Making first arm 33 and second arm 34 in substantially flush with positive pressure generating portion 32 can improve productivity, thus achieving a highly practical structure.

First arm 33 and second arm 34 extend toward the inner diameter side (lower direction in FIG. 5) obliquely. For first arm 33, the boundary of first arm 33 and second step 31 extends toward inner diameter side at an angle of 12° with respect to the longitudinal centerline of head slider 5. For second arm 34, the boundary of second arm 34 and second step 31 extends toward inner diameter side at an angle of 30° with respect to the longitudinal centerline of head slider 5. A magnetic head is mounted on the center of the part most adjacent to recording medium 2 at the side of the outermost air outlet end of second air bearing 30.

The fluctuations of the flying height of head slider 5 from the inner diameter side to the outer diameter side of recording medium 2 in disk drive 1 incorporating such head slider 5 are shown in FIG. 6. Now, the flying height is the distance from the magnetic head mounted on head slider 5 to the surface of recording medium 2.

As shown in FIG. 6, the use of the above head slider 5 can inhibit the fluctuations of the flying height ΔFH in the outer and inner diameter of recording medium 2 under the above conditions to approximately 0.5 nm or smaller (target flying height being 12 nm).

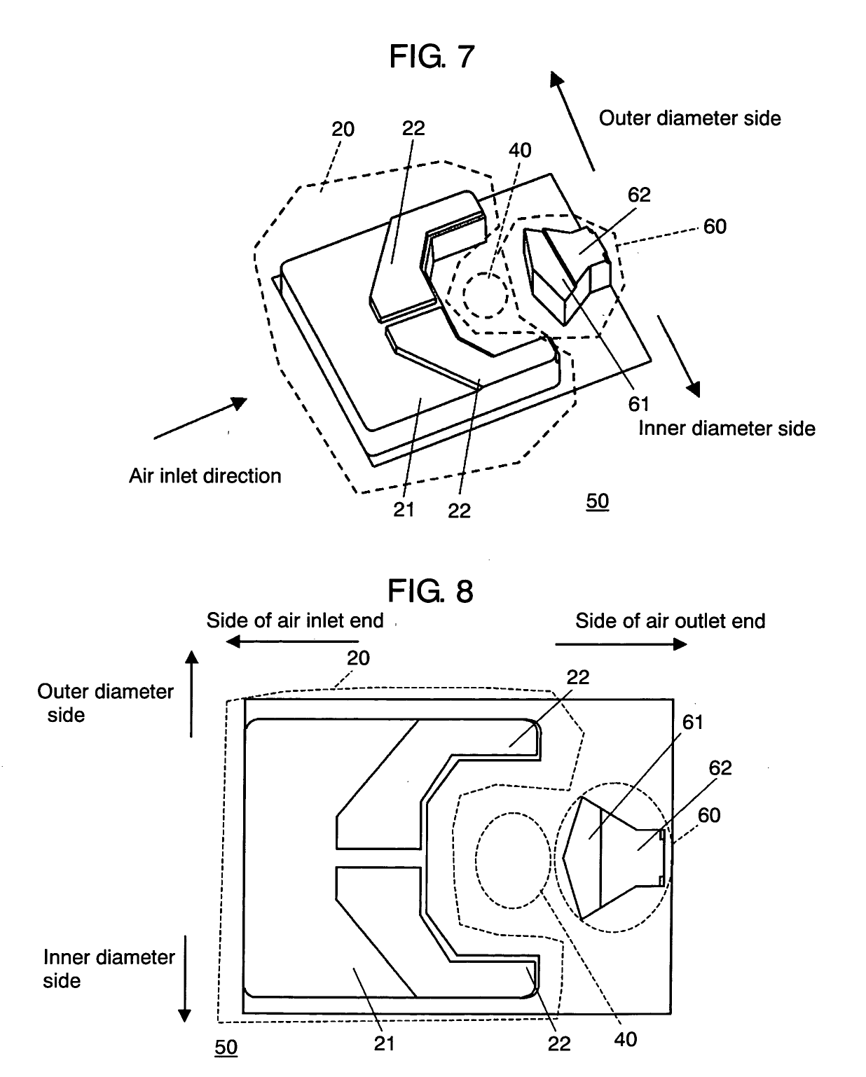

Now, to clearly describe the effect of the head slider in disk drive 1 in accordance with the exemplary embodiment, FIGS. 7 and 8 show a structure of head slider 50 in accordance with a comparative example. In comparison with head slider 5 in disk drive 1 of the exemplary embodiment of the present invention, head slider 50 of the comparative example is different in that second air bearing 60 has neither first arm 33 nor second arm 34 (second air bearing 61 being not surrounded by two arms). The other structures, i.e. the structure of first air bearing 20, and second air bearing 60 having second step 61 and positive pressure generation part 62, are the same as those of head slider 5.

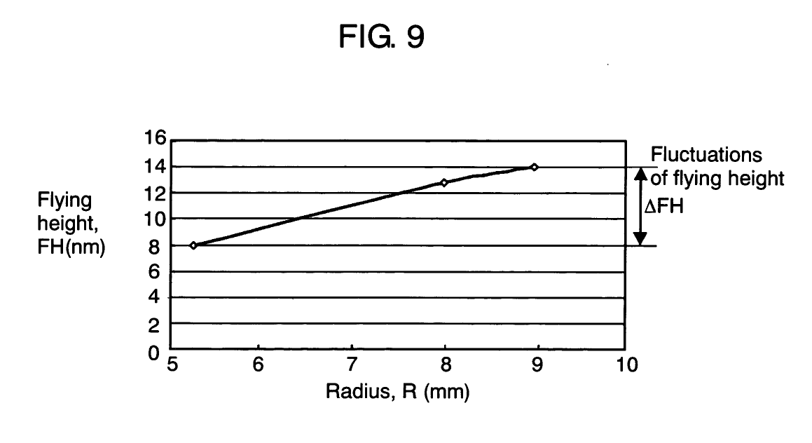

In the disk device incorporating head slider 50 of such a comparative example, the fluctuations of the flying height of head slider 50 from the inner diameter side to the outer diameter side of recording medium 2 is shown in FIG. 9.

As shown FIG. 9, in a disk drive incorporating head slider 50 of the comparative example, the flying height gradually increases from the inner diameter side to the outer diameter side of recording medium 2. Fluctuations ΔFH reach to approximately 6 nm. In other words, head slider 5 of this exemplary embodiment can inhibit fluctuations of the flying height ΔFH from approximately 6 nm to approximately 0.5 nm by providing first arm 33 and second arm 34 in second air bearing 30 on the air lubricating surface, in comparison with head slider 50 of the comparative example.

The reason why fluctuations of the flying height ΔFH of head slider 5 in disk drive 1 of this exemplary embodiment is inhibited as described above is given from the viewpoint of pressure distribution.

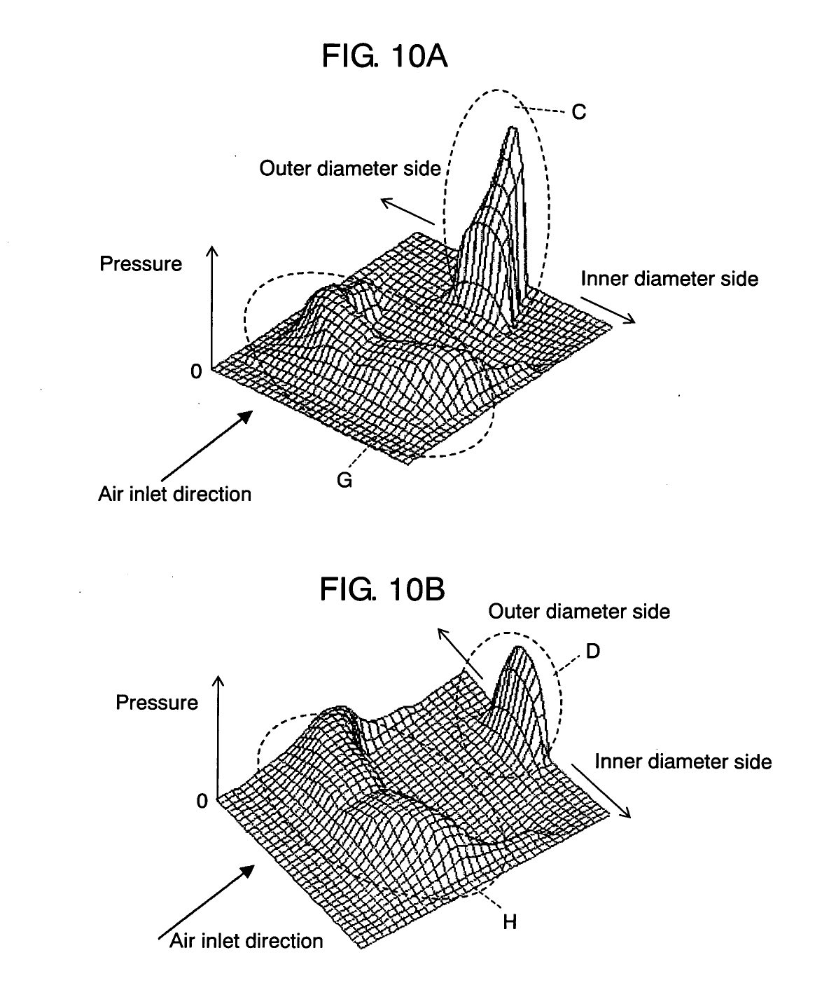

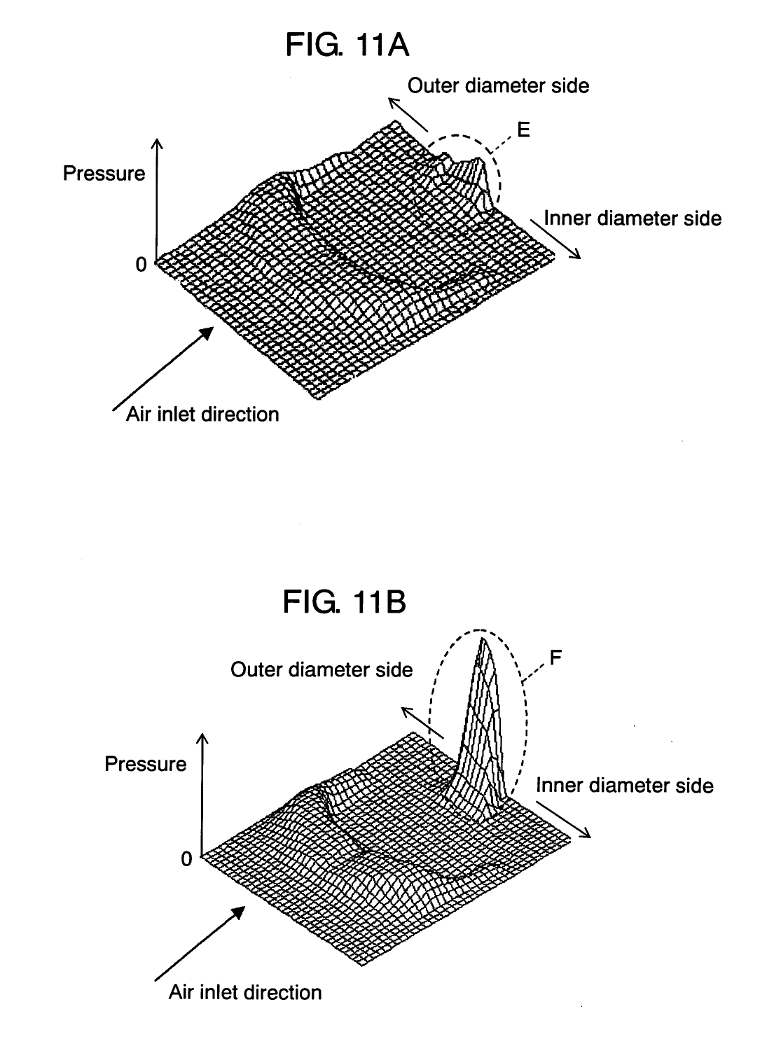

FIG. 10A shows pressure distribution of head slider 50 of the comparative example on the outer diameter side of the recording medium. FIG. 10B shows pressure distribution of head slider 50 of the comparative example on the inner diameter side. FIG. 11A shows pressure distribution of head slider 5 of the present invention on the outer diameter side of the recording medium. FIG. 11B shows pressure distribution of head slider 5 of the present invention on the inner diameter side.

Each of FIGS. 10A, 10B, 11A, and 11B shows the pressure distribution generated on the air lubricating surface of the head slider by a three-dimensional graph. In each graph, the upper direction shows that relative pressure value is positive (higher than atmospheric pressure). The lower direction shows that relative pressure value is negative (lower than atmospheric pressure).

As shown in FIGS. 10A and 10B, the pressure distribution of head slider 50 of the comparative example has positive pressure areas G and H generated by first air bearing 20, and positive pressure areas C and D generated by second air bearing 60 on both of the outer and inner diameter sides.

First, FIGS. 10A and 10B are compared. In head slider 50 of the comparative example, no large difference in pressure distribution is seen between positive pressure areas G and H, which is considered to be generated by first air beading 20.

However, when positive pressure area C of FIG. 10A is compared with positive pressure area D of FIG. 10B in the pressure distribution of head slider 50 of the comparative example, the pressure peak value of positive pressure area C of FIG. 10B on the outer diameter side is larger than the pressure peak value of positive pressure area D of FIG. 10B on the inner diameter side.

The reason of this phenomenon is considered as follows. Generally, when recording or reproduction is performed on rotating recording medium 2 by floating head slider 50, the velocity at which air flows between head slider 50 and recording medium 2 (hereinafter referred to as a circumferential velocity) is larger in the outer diameter side than in the inner diameter side of recording medium 2. This difference in circumferential velocity varies the flying height of head slider 50 depending on the position of recording media 2. In other words, it is highly possible that the flying height on the outer diameter side is larger than that on the inner diameter side in the use of head slider 50 of comparative example.

On the other hand, when positive pressure area E of FIG. 11A on the outer diameter side is compared with positive pressure area F of FIG. 11B on the inner diameter area in the pressure distribution of head slider 5 in disk drive 1 of this exemplary embodiment, the pressure peak value of positive pressure area E of FIG. 11A on the outer diameter side is smaller than the pressure peak value of positive pressure area F of FIG. 11B on the inner diameter side.

As described above, head slider 5 of this exemplary embodiment is designed so that the pressure value generated by second air bearing 30 on the inner diameter side is larger than the positive pressure value generated by second air beading 30 on the outer diameter side by providing first arm 33 and second arm 34. This design cancels fluctuations of the flying height caused by the difference in circumferential velocity between the inner and outer diameter, thus minimizing fluctuations of the flying height ΔFH in the inner and outer diameter.

Now, the reason why the pressure generated on the outer diameter side of recording medium 2 by second air bearing 30 of head slider 5 of this exemplary embodiment is smaller than the pressure generated on the inner diameter side is further detailed.

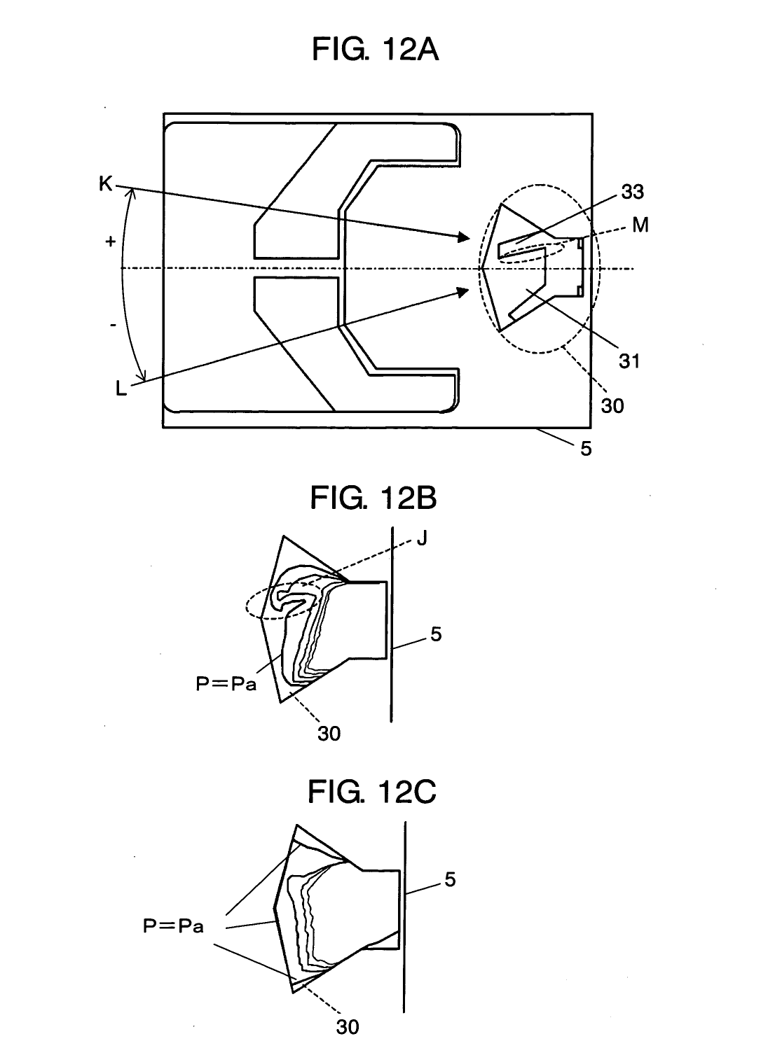

FIG. 12 is a diagram for illustrating the pressure generated in second air bearing 30 of head slider 5 of this exemplary embodiment. FIG. 12A is a plan view showing the structure of the air lubricating surface of head slider 5. FIG. 12B is a diagram showing pressure distribution generated by second air beading 30 of head slider 5 on the outer diameter side. FIG. 12C is a diagram showing pressure distribution generated by second air beading 30 of head slider 5 on the inner diameter side. In FIGS. 12B and 12C, the pressure value distribution generated in second air bearing 30 is shown by isobars. In FIGS. 12B and 12C, the isobar along which pressure P is equal to atmospheric pressure Pa is shown by P=Pa. In each of FIGS. 12B and 12C, the pressure on the right side of isobar P=Pa is higher, and the pressure on the left side thereof is lower.

In FIG. 12A, when head slider 5 in disk drive 1 of this exemplary embodiment is positioned on the outer diameter side of recording medium 2, air flows in K direction (4.8°). When head slider 5 in disk drive 1 is positioned on the inner diameter side of recording medium 2, air flows in L direction (−16.3°).

First, when head slider 5 is positioned on the outer diameter side of recording medium 2, as shown in FIG. 12B, there is an area in which negative pressure is generated (hereinafter referred to as a negative pressure generating area), e.g. area J on second air bearing 30. It is also apparent that the overall pressure on the left side of the diagram is low. On the other hand, when head slider 5 is positioned on the inner diameter side, as shown in FIG. 12C, in almost all the area except top and bottom ends of the diagram on second air bearing 30, positive pressure is generated, and no negative pressure generating area exists.

Negative pressure generating area J existing when head slider 5 in disk drive 1 of this embodiment is positioned on the outer diameter side of recording medium 2 is considered to correspond to generation of negative pressure in area M of FIG. 12A, i.e. boundary M between first arm 33 and second step 31. Because the angle formed by the boundary between first arm 33 and second step 31, and the longitudinal centerline of head slider 5 (−12° in this embodiment) is smaller than the angle formed by the centerline and air inlet direction K (4.8° in this embodiment), negative pressure is considered to be generated in such area M. In other words, from the viewpoint of M on the outer diameter side, when an airstream flows in air inlet direction K, the air compressed between first arm 33 and opposed recording medium 2 flows into a larger space between second step 31 and opposed recording medium 2. At this time, the airstream diffuses and thus negative pressure is generated.

On the other hand, in FIG. 12A, when head slider 5 is positioned on the inner diameter side of recording medium 2, the angle formed by the boundary between first arm 33 and second step 31, and the longitudinal centerline of head slider 5 (−12°) is larger than the angle formed by the centerline and air inlet direction L (−16.3°). For this reason, positive pressure is considered to be generated in the boundary between first arm 33 and second step 31 toward an airstream. In other words, from the viewpoint of M on the inner diameter side, when an airstream flows in air inlet direction L, the airstream flows from a space between second step 31 and opposed recording medium 2 into a smaller space between first arm 33 and opposed recording medium 2. At this time, the airstream is compressed and thus positive pressure is generated.

As described above, in head slider 5 in disk drive 1 of this embodiment, adjusting extending direction α of first arm 33 disposed on the outer diameter side of the slider as required can adjust the amount of positive pressure according to skew angle D, rotational speed, and other factors of disk drive 1. Thus, fluctuations of the flying height on the inner and outer diameter can be inhibited.

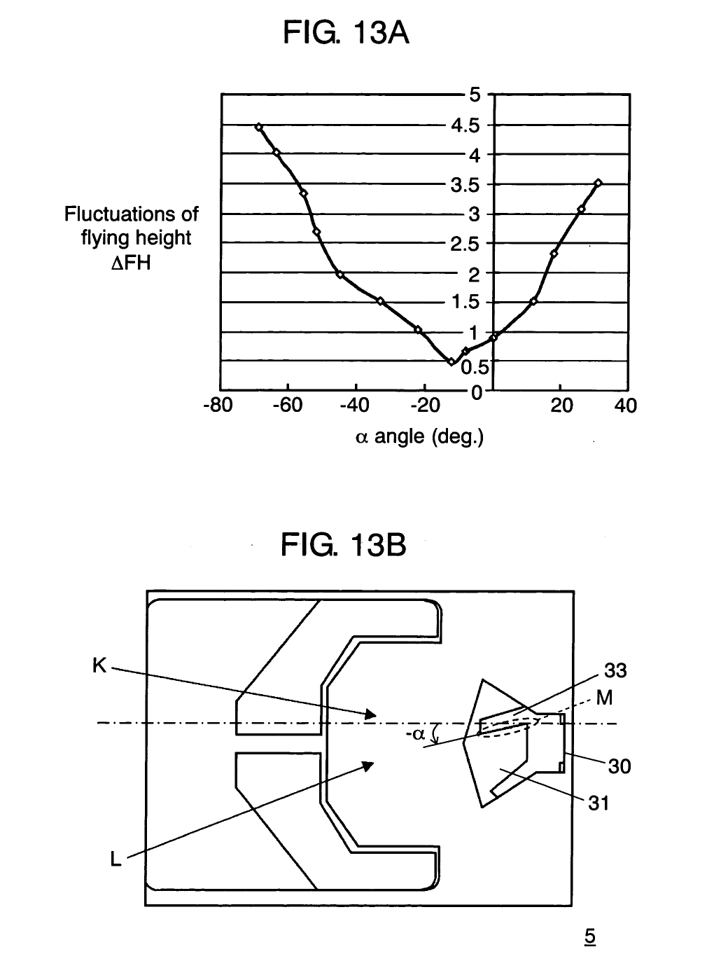

FIG. 13A shows fluctuations of the flying height ΔFH on the inner and outer diameter in disk drive 1, when extending direction α of first arm 33 of head slider 5 of this embodiment is changed under the above conditions, for example. FIG. 13B shows the definition of extending direction α of first arm 33. As shown in FIG. 13B, the angle formed by the boundary between first arm 33 and second step 31 and longitudinal direction of head slider 5 is extending direction α of first arm 33. When the arm is oriented toward the upper side (outer diameter side) of the longitudinal centerline of head slider 5, extending direction α takes a positive value. When the arm is oriented toward the lower side (inner diameter side), extending direction α takes a positive value.

As shown in FIG. 13A, in head slider 5 in disk drive 1 of this embodiment, when extending direction α is approximately −12°, fluctuations of the flying height ΔFH can be minimized.

Practically, it is desirable to inhibit the fluctuations of the flying height to approximately 1.5 nm for the flying height of approximately 12 nm. According to the relation of FIG. 13A, extending direction α of first arm 33 ranging from −30° to 10° can inhibit the fluctuations of the flying height to approximately 1.5 nm. It is more desirable to inhibit fluctuations of the flying height ΔFH to approximately 1 nm for the flying height of approximately 12 nm. According to the relation of FIG. 13A, extending direction α of first arm 33 ranging from −20° to 0° can inhibit the fluctuations of the flying height to approximately 1 nm.

According to inventors' discussion, setting extending direction a of first arm 33 in the definition of the angle in FIG. 13B smaller than air inlet direction K on head slider 5 on the outer diameter side of recording medium 2 and larger than air inlet direction L on the inner diameter side can generate the above positive pressure.

In other words, when the extending direction of first arm 33 is larger than air inlet direction K on the outer diameter side (positive direction), negative pressure generating area J of FIG. 12B in area M of FIG. 12A is not produced, and positive pressure is generated in area M. On the other hand, when extending direction α is smaller than air inlet direction L on the inner diameter side, i.e. toward a further inner side (negative direction), negative pressure generating area J is produced in area M on head slider 5 even on the inner diameter side, thus decreasing the flying height of head slider 5 on the inner diameter side. For these reasons, setting the extending direction of first arm 33 smaller than air inlet direction K on head slider 5 on the outer diameter side of recording medium 2 and larger than air inlet direction L on the inner diameter side can generate the above negative pressure in area M on the outer diameter side.

For example, in disk drive 1 of this embodiment, skew angle DO on the outer diameter side is 4.8° and skew angle DI on the inner diameter side is −16.3°. Then, setting the following relation of extending direction α:
−16.3°≦α≦4.8°
can inhibit fluctuations of the flying height ΔFH of head slider 5 on the inner and outer diameter sides.

Further, inventors' discussion shows that changing width C of first arm 33 of head slider 5 of this embodiment can also adjust fluctuations of the flying height ΔFH of on the inner and outer diameter sides of recording medium 2.

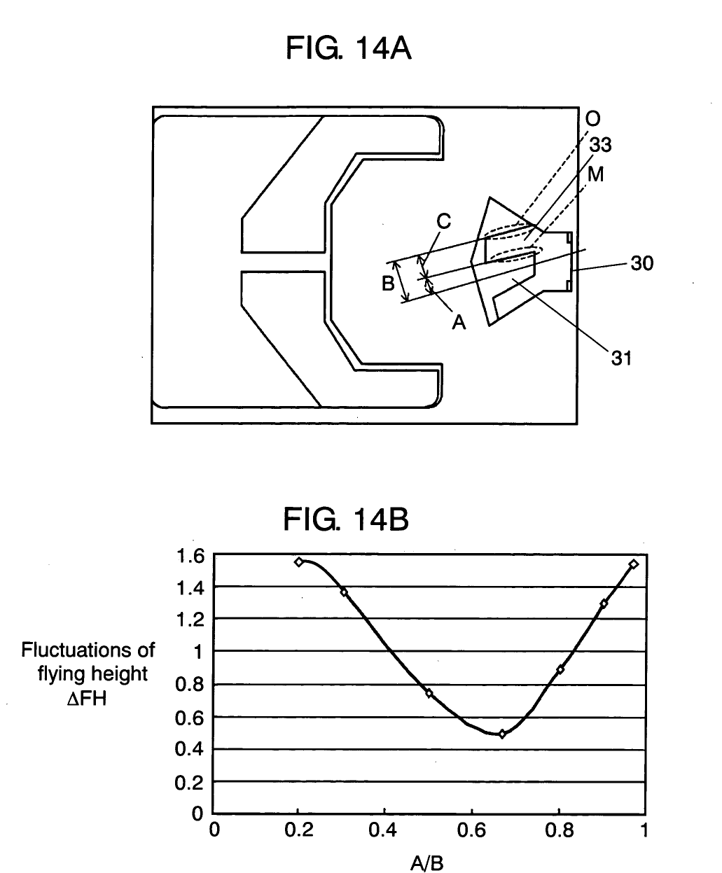

The above idea is described with reference to FIG. 14. FIG. 14A is a diagram illustrating the definition of width C of first arm 33 of head slider 5 in disk drive 1 of this embodiment. FIG. 14B is a graph showing fluctuations of the flying height ΔFH of head slider 5 on the inner and outer diameter sides of recording media 2 when width C of first arm 33 is changed.

As shown in FIG. 14A, set the width of first arm 33 in the direction orthogonal to its extending direction α to C, the half value of the width of second step 31 in the same direction as C to A, and the sum of C and A to B. As described above, the extending directions of first arm 33 and second arm 34 are −12° and −30°, respectively.

As shown FIG. 14B, when the value of A/B takes 0.67 under these conditions, fluctuations of the flying height ΔFH are 0.5 nm, i.e. the minimum value.

Then, satisfying the condition where the target flying height is 12 nm, and fluctuations ΔFH are within 1.5 nm is considered. A relation of 0.3≦A/B≦0.9 can inhibit the fluctuations of the flying height on the inner and outer diameter sides within 1.5 nm.

Further, desirably, satisfying the conditions where the target flying height is 12 nm, and fluctuations ΔFH are within 1 nm is considered. A relation of 0.4≦A/B≦0.85 can inhibit the fluctuations of the flying height on the inner and outer diameter sides within 1 nm.

The reason is considered as follows. Too large width C of first arm 33 causes generation of too much positive pressure in the boundary area (area O) between first arm 33 and the outer diameter side of second step 31, and this positive pressure cancels the negative pressure generated in area M. This makes the flying height of head slider 5 on the outer diameter side too large. In contrast, too small width C cannot cause generation of sufficient positive pressure in area O, thus making the flying height on the outer diameter side too small.

As described above, appropriately selecting extending direction a and width C of first arm 33 according to the difference in skew angle D of head slider 5 in disk drive 1 of this embodiment between the outer and inner diameter sides can provide head slider 5 having minimum fluctuations of the flying height ΔFH.

Further, it has been proven that head slider 5 designed under optimal conditions in disk drive 1 of this embodiment has more excellent shock resistance than a head slider of a comparative example.

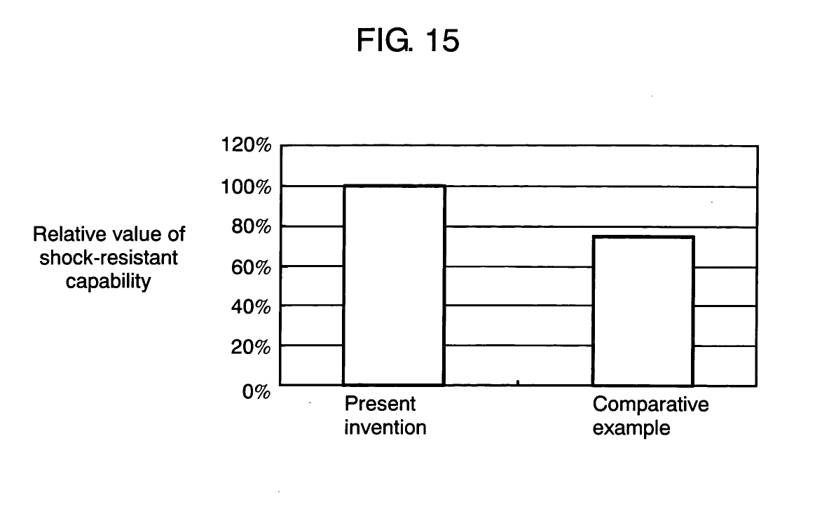

FIG. 15 is a graph showing results of comparing shock resistance between head slider 5 of this embodiment of and head slider 50 of the comparative example. FIG. 15 shows a relative value (%) of the shock resistance value (how much shock the slider can withstand to read or write signals?) of head slider 50 of the comparative example with respect to the shock resistance value of head slider 5 (100%) of this embodiment.

As shown in FIG. 15, head slider 5 of this embodiment is approximately 25% more shock-resistant than head slider 50 of the comparative example.

The reason is considered as follows. In a general head slider, as shown in FIGS. 10A and 10B, the pressure generated between the periphery of the head (are D) and recording medium 2 on the inner diameter side is smaller than the pressure generated around the head (area C) on the outer diameter side at which the velocity is higher. For this reason, when disturbances such as a drop are applied to disk drive 1, it is likely that the head slider collides with recording medium 2 on the inner diameter side at which the circumferential velocity is lower. In contrast, in head slider 5 of this embodiment, as shown in FIGS. 11A and 11B, the pressure around the head (area F) on the inner diameter side can be made higher than the pressure around the head (area E) on the outer diameter side. This can decrease the possibility of collision between head slider 5 and recording medium 2 on the inner diameter side at which the circumferential velocity is lower.

Further, designing head slider 5 of this embodiment so that the extending direction of second arm 34 (the direction of the boundary between second arm 34 and second step 31) is smaller than air inlet angles K and L on the outer and inner diameter sides, respectively, can provide positive pressure for obtaining the necessary flying height at the boundary between second arm 34 and second step 31. Second arm 34 is structured so as to generate the positive pressure with respect to air inlet direction L on the inner diameter side, e.g. to form an angle smaller than −16.8° with respect to the longitudinal direction of head slider 5. In this embodiment, an example of −30° is shown. This structure allows generation of the positive pressure between second arm 34 and second step 31 in all the area of recording medium 2 on the inner and outer diameter sides, thus achieving high shock resistance.

As described above, structuring disk drive 1 using head slider 5 of this embodiment can inhibit fluctuations of the flying height on the inner and outer diameter sides of recording medium 2 to a minimum of 0.5 nm while achieving a low flying height of 12 nm and a high shock resistance.

In this embodiment, the floating characteristics of the head slider is described on the basis of discussion results under predetermined conditions including the number of revolutions of 3,600 r/m. However, the head slider of the present invention is not limited to the number of revolutions, load, size of the head slider, and other factors when it is used. For example, of course, the head slider of the present invention exhibits excellent shock resistance in all the areas of the number of revolutions practically used for a magnetic disk drive. Further, the head slider of the present invention can exhibit the excellent shock resistance even at a relatively low number of revolutions ranging from approximately 2,000 to 5,000 r/m, which is generally used for a small magnetic disk drive.

This embodiment is described by using a so-called PICO slider as an example. However, the size of the head slider of the present invention is not limited to this size. In the use of a so-called 20% slider or FEMTO slider having a size of long dimension×short dimension=0.85 mm×0.7 mm, for example, similar effects can be obtained.

Further, the head slider of the present invention is not limited to the load in use. For an example, PICO slider or FEMTO slider can be used with a load ranging from approximately 0.5 g to 2.5 g.

In the head slider of the present invention, the shape of first air bearing 20 is not limited. In the description of head slider 5 of this embodiment, as shown in FIGS. 4 and 5, the case in which side rails 22 of first air bearing 20 is shaped to bend toward the side of the air outlet end in the vicinity of the short dimension of head slider 5. However, the shape of side rails 22 in the head slider of the present invention is not limited. Further, when the head slider is structured to have side rails 22, a structure more resistant to shocks in the roll direction is achieved. However, of course, a head slider having no side rails 22 is included in the head slider of the present invention.

In this embodiment, a magnet disk drive is described as an example. However, the disk drive of the present invention is not limited to a magnet disk drive. Of course, it includes a disk drive using floating type head slider, such as a photo-magnetic disk drive and optical disk drive.

The use of a disk drive, head slider, and head supporting device of the present invention has an advantage of providing a disk drive, head slider, and head supporting device capable of inhibiting fluctuations of the flying height on the inner and outer diameter sides of the recording medium while achieving a high shock resistance and a low flying height. Thus, the present invention is useful as a disk drive, head slider, and head supporting device, such as a magnetic disk drive using a floating type head slider.

1. A disk drive comprising:
(a) a rotating disc-shaped recording medium; and
(b) a head slider floated by an airstream flowing between the recording medium and the head slider and used at different skew angles with respect to recording tracks on inner and outer diameter sides of the recording media, the head slider including:
(i) a first air bearing provided on a side of an air inlet end; and
(ii) a second air bearing provided on a side of an air outlet end, the second air bearing of the head slider including:
a positive pressure generating portion provided on a side of an outermost air outlet end; and
a first arm and a second arm on an inner diameter side of the first arm, respectively extending from both ends of the positive pressure generating portion toward the air inlet end;
wherein extending directions of the first arm and the second arm of the head slider are disposed so that pressure generated by the second air bearing when the head slider is used on the inner diameter side of the recording medium is higher than the pressure generated by the second air bearing when the head slider is used on the outer diameter side of the recording medium.

2. The disk drive of claim 1, wherein the extending direction of the first arm is disposed so that pressure generated between the first arm and a recess surrounded by the first arm, the second arm, and the positive pressure generating portion when the head slider is used on the outer diameter side of the recording medium is lower than the pressure generated between the first arm and the recess when the head slider is used on the inner diameter side.

3. The disk drive of claim 2, wherein
the second arm extends in a direction as to have a smaller angle than air inlet directions when the head slider is used on the outer and inner diameter sides of the recording medium; and
the first arm extends in a direction as to have a smaller angle than the air inlet direction when the head slider is used on the outer diameter side of the recording medium and a larger angle than the air inlet direction when the head slider is used on the inner diameter side of the recording medium.

4. The disk drive of claim 1, further including a head on an outermost surface of the second air bearing of the head slider on the side of the outermost air outlet end thereof.

5. The disk drive of claim 3, wherein the extending direction of the first arm of the head slider ranges from −30° to 10° with respect to a longitudinal direction of the head slider.

6. The disk drive of claim 5, wherein a relation of 0.3≦A/(A+C)≦0.9 is satisfied, where C is a width of the first arm of the head slider in a direction orthogonal to the extending direction of the first arm, and A is a half value of a width of the recess on the side of the air inlet end in a direction orthogonal to the extending direction of the first arm.

7. The disk drive of claim 1, further including a pair of side rails in the first air bearing of the head slider.

8. The disk drive of claim 7, wherein the pair of side rails, the first arm, the second arm, and the positive pressure generating portion are provided at the same height from a base surface.

9. The disk drive of claim 1, further including a head supporting device, the head supporting device including a suspension for imparting a predetermined urging force to the head slider from a direction opposite to a side having the first air bearing and the second air bearing.

10. The disk drive of claim 9, wherein the suspension includes a pivot for imparting the predetermined urging force to the head slider.

11. The disk drive of claim 1, further comprising:
a driving means for rotating the recording medium;
a pivoting means for pivoting a head supporting device radially of the recording medium; and
a controlling means for controlling rotation of the driving means and pivoting of the pivoting means.

12. The disk drive of claim 10, wherein, when a position where the pivot in the head supporting device is in contact with the head slider is set to a pivot position, a projection of a gravitational center of the head slider and a projection of the pivot position onto the recording medium substantially coincide with each other.

13. The disk drive of claim 4, wherein the recording medium is a magnetic recording medium, and the head is a magnetic head.

14. A head slider floated by an airstream flowing between a rotating disc-shaped recording medium and the head slider and used at different skew angles with respect to recording tracks on inner and out diameter sides of the recording media, the head slider including:
a first air bearing provided on a side of an air inlet end; and
a second air bearing provided on a side of an air outlet end, the second air bearing of the head slider including:
a positive pressure generating portion provided on a side of an outermost air outlet end; and
a first arm and a second arm on an inner diameter side of the first arm, respectively extending from both ends of the positive pressure generating portion toward the air inlet end;
wherein extending directions of the first arm and the second arm of the head slider are disposed so that pressure generated by the second air bearing when the head slider is used on the inner diameter side of the recording medium is higher than the pressure generated by the second air bearing when the head slider is used on the outer diameter side of the recording medium.

15. A head supporting device comprising:
a head slider floated by an airstream flowing between a rotating disc-shaped recording medium and the head slider and used at different skew angles with respect to recording tracks on inner and out diameter sides of the recording media, the head slider including:
a first air bearing provided on a side of an air inlet end; and
a second air bearing provided on a side of an air outlet end, the second air bearing of the head slider including:
a positive pressure generating portion provided on a side of an outermost air outlet end; and
a first arm and a second arm on an inner diameter side of the first arm, respectively extending from both ends of the positive pressure generating portion toward the air inlet end;
wherein extending directions of the first arm and the second arm of the head slider are disposed so that pressure generated by the second air bearing when the head slider is used on the inner diameter side of the recording medium is higher than the pressure generated by the second air bearing when the head slider is used on the outer diameter side of the recording medium; and
a suspension for imparting a predetermined urging force to the head slider from a direction opposite to a side having the first air bearing and the second air bearing.
